(19) United States
(12) Patent Application Publication
(10) Pub. No.: US 2026/0334350 A1
(43) Pub. Date: Oct. 29, 2026

(54) SEED PILL

(71) Applicant: Instant Seed GmbH, Mahlow (DE)

(72) Inventors: Adam Krecisz, Berlin (DE); Thomas Krecisz, Berlin (DE)

(21) Appl. No.: 19/107,762

(22) PCT Filed: Aug. 4, 2023
(86) PCT No.: PCT/DE2023/000090

§ 371 Date: Feb. 28, 2025

(30) Foreign Application Priority Data
Sep. 1, 2022 (DE) 10 2022 003 191.4

(51) Int. Cl. A01C 1/06

(52) U.S. Cl. CPC A01C 1/06

(57) ABSTRACT

Disclosed is a seed pill comprising a core (1), a shell/adhesive layer (2) and a seed layer (3), characterized in that the seed pill includes a fiber layer (4) which at least partly covers the seeds in the seed layer (3).

### FIELD OF THE INVENTION

A seed pellet with at least one seed per pellet is described. The pellet has a core with a pelleting/adhesive layer to which the seeds adhere. The seed pellet is suitable in particular for small, light seeds and is preferably applied onto the surface of the soil.

### PRIOR ART AND BACKGROUND OF THE INVENTION

It is known that seeds of many crop and ornamental plants are problematic to sow due to their shape, size, or weight. In the case of reforestation or afforestation of woodland, tree planting turns out to be particularly difficult. Bare and uneven areas as well as areas that are difficult to access can only be inadequately planted with forest using planting machines. Planting trees or the sowing of tree seeds over large areas is very time-consuming and very costly due to the deployment of personnel.

“Light germinators” mostly have small seeds, and do not therefore have sufficient energy to penetrate a soil layer and need light or heat to germinate. They should therefore at most be pressed down onto the soil on sowing and not covered with earth.

Other necessary conditions for successful germination and development are: sufficient moisture during the initial vegetation period, soils not at risk of drifting or capping, and safe sites in the microrelief (e.g., troughs) if the seeds are not pressed into the soil.

It is already known to increase the size of seeds with a pelleting substance in order to simplify handling and improve germination behavior through better soil contact. The resultant pellets or pills generally contain more than just one seed. In the case of seeds with low germinability, a pellet or pill needs to contain at least one germinable seed.

EP0616758B1 describes a method for producing pelleted seeds with a number of seeds per grain, in which the seeds are deposited on the cores in such a manner that they cannot be stripped off.

US5623781A describes pellets or pills in which at least two small seeds are adhered to a core. Depending on the embodiment, the seeds are located in various regions of a pellet.

The binding substances used in the solutions mentioned are water-soluble or become soft after absorbing water and may melt away with the seeds (e.g., in the event of heavy rain). The seeds then become covered with a layer of soil/mud, which hampers germination, or the seeds remain lying on the soil and may quickly dry out. Melting would not take place if the pellets were introduced under the soil, but that is obviously not the case because the pellets are also provided for light germinators and are thus sown on the soil surface.

### TECHNICAL PROBLEM UNDERLYING THE INVENTION

It is the object of the invention to produce a seed pellet having the following features:
the pellet is sufficiently heavy to achieve good soil contact and thereby draw moisture out of the soil and convey it onward to the seeds
the seeds are adhered to the pellet in such a way that they cannot fall off the pellet and thereby dry out or become covered.
In a further embodiment, the pellet may itself store water and/or produce an additional water-conveying connection between the soil and the pellet and/or impart water-storing characteristics to the soil environment around the pellet.

### MAIN FEATURES OF THE INVENTION AND PREFERRED EMBODIMENTS

The technical problem is solved according to the invention by the features of Claim 1. Advantageous embodiments of the invention are revealed by Claims 2-6.

The pellet consists of a core with a pelleting/adhesive layer, a seed layer, a fibrous layer and possibly further layers.

The core preferably stores and conveys water or is pelleted with a water-storing and water-conveying layer. The core may consist of
a grain of sand, stone chip, perlite, pumice, pieces of wood or any granular material,
granulated minerals or granulated plant-based material, which may contain additives,
and plant seeds, which may serve inter alia as a nutrient depot.

Which material the core consists of depends on many factors, including:
cost and effort involved in core production
availability
biological requirements of the seeds/plants such as pH, germination time, etc.
soil type—e.g., loam for sandy soils, perlite for heavy soils.

The grain size preferably amounts to 2 to 10 mm (maximum dimensions). Too small grains make seed adhesion more difficult, while too large grains increase the weight of the pellets, thereby leading to higher transportation, storage and sowing costs but in return ensuring better soil contact. Larger grains also make it possible to accommodate larger seeds or larger quantities of seeds on the pellet. A pelleting layer may be attached to the cores to change the shape of the grains and/or even out or increase size. The pelleting layer may simultaneously serve as the adhesive layer. The adhesive layer may, however, form the surface of a grain if the grain consists of a material with adhesive characteristics (such as e.g., loam). The layer is designated “pelleting/adhesive layer” and consists of the core material or a suitable binding substance and has the function of attaching the seeds to the grain.

The pelleting/adhesive layer should be matched to the seeds so as not to have a negative effect on germination. Binding substances which may be used for the pelleting/adhesive layer may include not only loam, bentonite or other minerals but also the binding substances conventionally used for seed pellets, such as PVA, dextrins, gum arabic, etc.

A further layer is termed the “seed layer” and is formed by the seeds. In most cases, the seeds cover only a small part of the pelleting/adhesive layer and are adhered to the layer. The seeds in question are small seeds, such as often arise with vegetables, flowers and herbs, and above all are small tree seeds such as birch, alder or poplar. The seed layer consists of at least two seeds, but generally of many more. Because of the different germinability of different seeds, it is generally the case that one pellet contains at least one germinable seed. During sowing, some of the seeds will be situated on the underside of the pellet, thus possibly hampering germination; however, most of the seeds will remain above the soil.

A further layer of the seed pellet consists of fibers and is termed the “fibrous layer”. The fibers adhere to the pelleting/adhesive layer between the seeds and form a fibrous mesh. The pelleting/adhesive layer is thereby stabilized and does not melt out of the core even if greatly moistened.

The fiber length should, at least in part, be greater than the diameter of the seeds. In this way, a number of fibers encircle the seeds in the manner of a mesh, the ends of the fibers being embedded in the pelleting/adhesive layer. If sufficient fibers encircle a seed, the force with which the seed is held is relatively great, even if the pelleting/adhesive layer is not yet hardened. Once the layer is hardened, the force is even greater and the seeds are also held firm during transportation and sowing and do not fall out of the seed pellet. The fibrous layer does not fully cover the pellet; only sufficient fibers to stabilize the pelleting/adhesive layer and to hold the seeds sufficiently firmly on the pellet are needed. How many fibers are needed for this purpose depends on the characteristics of the pelleting/adhesive layer, the seed type and size and the characteristics of the fibers themselves. Fibers of plant-based origin, such as jute, hemp, linen, viscose, etc., are preferably used.

Due to this seed pellet structure, the seeds are held on the surface of the pellet without the pelleting/adhesive layer having very strong adhesive properties which might possibly have a negative effect on germination. The pelleting/adhesive layer is thus intended merely to enable adhesion of the seeds and to convey moisture to the seeds.

A further layer, termed the “wash-out layer”, may be present on the fibrous layer. The layer provides additional protection for the seeds during transportation and sowing, but its main purpose is to ensure better contact between pellet and soil. This is achieved by the layer consisting of a material which can be easily washed out when water is supplied, e.g., through watering or rainfall, the material being capable of storing or at least conveying water. Washing out here means that the layer completely or mostly melts into the soil when water is supplied. The melted material forms a connection, a bridge in the form of a ring around the pellet, and, due to its development, is very well connected with the soil and the pellet and is thus very able to transport water to the pellet.

The wash-out layer may consist of mineral and/or biological constituents and may also contain additives, such as nutrients or fertilizers, which assist growth of the germinated plants and have a thickness of between a few tenths of a mm and a few mm.

A plant must have a sufficient water supply for successful germination and initial development. “Superabsorbent polymers”, known as SAPs, are helpful here, as they can absorb and then release multiples of their own weight in water. The wash-off layer may consist solely of SAP or partly of SAP and partly of other mineral and/or biological constituents and a binding substance.

On absorbing water, SAPs form a gel. The gel detaches from the pellet, falls onto the soil and forms a connection between soil and pellet. Due to their great capacity for binding water, SAPs form a moist zone around and under the pellet and slow down drying out of the pellet in dry seasons. SAPs are hydrophilic and may sometimes bind water from moist air, mist or dew.

Some of the SAP will enter the soil under the pellet and form a water reservoir for young plants. SAPs may store and release water for a number of years until they biodegrade.

The seed pellet may also have a protective/colored layer. The layer may impart better flow behavior to the pellet or determine its appearance and may also have water-repellent properties. However, the layer should above all not prevent the wash-out layer from melting. The layer may, e. g., consist of talc and a colorant. The layer is desirable, in particular, if the wash-out layer contains a SAP, because it protects the latter from absorbing moisture from the air during transportation, storage and sowing. The protective/colored layer then preferably contains a wax or a wax mixture, preferably of plant-based origin. On contact with water, however, the SAP absorbs water, so increasing in volume, bursts the wax layer and melts into the soil with the layer.

### EXEMPLARY EMBODIMENT

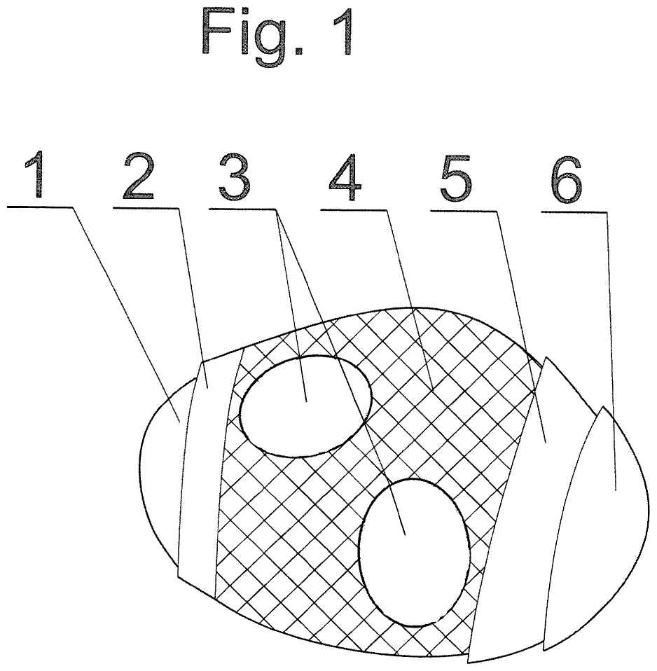

The structure of a seed pellet with birch seeds is illustrated schematically in FIG. 1.

The core 1 consists of an approximately round or oval stone approximately 5 mm in diameter and is coated with a pelleting/adhesive layer 2. The layer has a thickness of a few tenths of a mm and consists of loam. Due to the irregular shape of the grain, the layer thickness may vary at different points.

A seed layer 3 consists of birch seeds. The seeds are attached to the pellet by moistening the pelleting/adhesive layer 2, which thus becomes tacky, the individual seeds then adhering to the layer. On average four birch seeds are attached to one pellet, only covering the pelleting/adhesive layer 2 in part.

A fibrous layer 4 consisting of viscose fibers approximately 5 mm in length is located on the seed layer 3, the fibers forming a mesh. The fibers adhere to the points on the pelleting/adhesive layer 2 not covered by the seeds. The fibers are randomly distributed and extend in part over the seeds. The ends of the fibers extending over the seeds are adhered to the pelleting/adhesive layer 2 or embedded in the layer. If the pelleting/adhesive layer 2 dries out and hardens, the seeds are held firm by the fibers and do not fall off. The fibers cover only part of the pellet. The quantity of fibers should ensure, however, that the seeds are fixed sufficiently firmly. The mesh of fibers has no negative effect on germination of the seeds or their subsequent development as plants.

The pellet also has a further layer, termed the wash-out layer 5. The layer provides additional protection for the adhered seeds during transportation and sowing, but is intended to wash out easily, fall from the pellet onto the soil, and thus form a connection acting as a path for transporting moisture between soil and pellet. It consists of loam with a low clay content, is approximately 0.5 mm thick, and completely covers all the previous layers.

In another variant embodiment, the wash-out layer 5 contains not only loam but also a SAP or consists solely of a SAP. In the latter case, the SAP does not fully envelop the pellet, the wash-out layer 5 consisting merely of individual SAP particles which are located on the surface and are adhered to the pelleting/adhesive layer 2 between the seeds and fibers.

A protective/colored layer 6 consisting of talc and colorant is located on the wash-out layer 5. In the variant with a SAP, the layer contains wax.

1. A seed pellet having a core (1), a pelleting/adhesive layer (2) and a seed layer (3), characterized in that it has a fibrous layer (4) which covers the seeds in the seed layer (3) at least in part.

2. The seed pellet according to claim 1, characterized in that it comprises a wash-out layer (5).

3. The seed pellet according to claim 2, characterized in that the wash-out layer (5) contains a SAP.

4. The seed pellet according to claim 1, characterized in that it comprises a protective/colored layer.

5. The seed pellet according to claim 4, characterized in that the protective/colored layer contains wax.

6. The seed pellet according to claim 1, characterized in that it consists of the stated components.
